(19) United States
(12) Patent Application Publication
(10) Pub. No.: US 2002/0060466 A1
(43) Pub. Date: May 23, 2002

(54) Vehicle for producing and selling tofu

(76) Inventor: Haruyuki Toyoda, Kusu-gun (JP)

Correspondence Address: STEINBERG & RASKIN, P.C., 1140 AVENUE OF THE AMERICAS, 15th FLOOR, NEW YORK, NY, 10036-5803, US

(21) Appl. No.: 09/971,808

(22) Filed: Oct. 5, 2001

(30) Foreign Application Priority Data
Oct. 5, 2000 (JP) 2000-306795

(51) Int. Cl. B60P 3/00

(52) U.S. Cl. 296/24.1

(57) ABSTRACT

A purpose of the present invention is to supply freshly-made tasty tofu to customers anywhere. For a solution to the problem, the present invention provides a vehicle for producing and selling tofu including a generator and an interior which is divided into two spaces, one for producing the tofu and one for selling the tofu produced in the production space. The production space includes a cold store for storing the soya milk; a soya-milk heating unit; a work bench for dividing the tofu produced by the soya-milk heating unit; and a fixed basin. The sale space includes showcases for displaying the tofu produced; a checking-out section; and an entrance for allowing customers to go in and out.

### BACKGROUND OF THE INVENTION

1. Field of the Invention

This invention relates to a vehicle for producing tofu therein and selling the freshly-made tofu.

2. Description of Related Art

Producers/sellers of tofu generally start their work from early morning. Soya milk is initially made from soya beans, then heated after the addition of bittern. Typically, the whole amount of tofu for selling each day is produced during the early morning hours. The tofu produced is immersed in cold water or sometimes stored in a cold store, while on sale.

Soya milk made from soya beans has bittern added, and is then heated to solidify, resulting in tofu. It goes without saying that freshly-made tofu is warm because the soya milk has been heated. This warm tofu possesses a palatability peculiar to freshly-made and warm tofu.

However, tofu is produced in one operation in the early morning and sold all through the day. Most of the tofu produced must be immersed in cold water for storage. This does not permit most people to eat freshly-made, warm and tasty tofu. Further, the tofu exposed to water becomes watery and flavourless.

Some shops sell tofu not-exposed to water or freshly-made tofu as a special item. However, as a result of such shops being limited, only persons in the neighborhood of the shop can buy the special tofu. And if a person goes to buy the special tofu from a distance and taking time to do so, when the person brings it home, the tofu has lost its freshness and cannot provide the palatability of freshly-made tofu.

### SUMMARY OF THE INVENTION

It is an object of the present invention to provide a vehicle for producing and selling tofu which is adapted to supplying tasty freshly-made tofu to customers everywhere.

To attain this and other objects, a first aspect of the present invention provides a vehicle for producing and selling tofu characterized by including a generator and a production space which is provided inside the vehicle for producing tofu and furnished with: a cold store for storing soya milk; a soya-milk heating unit; a work bench for dividing the tofu produced by the soya-milk heating unit; and a fixed basin.

A second aspect of the present invention provides a vehicle for producing and selling tofu characterized by including a production space provided inside the vehicle for producing tofu, and a sale space provided inside the vehicle for selling the tofu produced in the production space, and furnished with: showcases for displaying the tofu produced; a checking-out section; and an entrance for allowing customers to go in and out.

According to the second aspect, when customers enter the sale space in the vehicle, they see the freshly-made steaming tofu and can realize its freshness.

A third aspect of the present invention provides a vehicle for producing and selling tofu characterized by further including a wall provided between the production space and the sale space.

According to the third aspect, a clean production space can be assured.

A fourth aspect of the present invention provides a vehicle for producing and selling tofu characterized by further including a water storage tank and a waste water tank.

According to the fourth aspect, the vehicle enables tofu to be produced anywhere. For this reason, tofu can be produced even while the vehicle is in motion, which does not waste time in transportation.

According to the first to fourth aspects, the vehicle succeeds in delivering freshly-made tofu anywhere.

### BRIEF DESCRIPTION OF THE DRAWINGS

FIG. 1 is an external side view of a vehicle of an embodiment according to the present invention.

FIG. 2 is a view of the inside of the vehicle of the embodiment when viewed from top.

### DETAILED DESCRIPTION OF THE PREFERRED EMBODIMENT

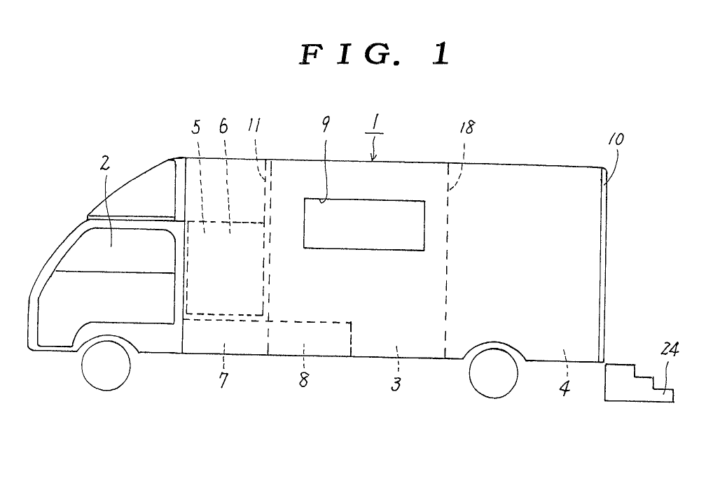

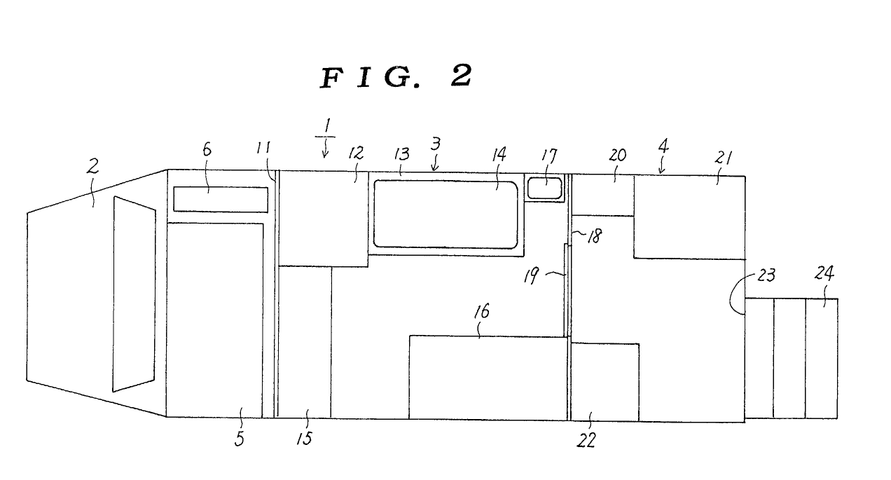

FIG. 1 and FIG. 2 illustrate a preferred embodiment according to the present invention.

As illustrated in FIG. 1, a producing and selling tofu vehicle 1 according to the present invention includes a production space 3 and a sale space 4 to the rear of the driver's seat 2.

Between the driver's seat 2 and the production space 3, there are provided a generator 5 and an outdoor unit 6 of an air conditioner. A wall 11 is provided between the production space 3 and the generator 5 and outdoor unit 6, for decreasing the transfer of noise from the operating generator and the like into the production space 3, and for hygienic reasons.

The vehicle has a front half floor on a higher level than that of the rear half floor, providing space for a water storage tank 7 and a waste water tank 8 under the front half floor. The water in the water storage tank 7 is for cleaning the containers and utensils used when tofu is produced and for washing the hands of the worker. The water drained away after use is stored in the waste water tank 8.

On a side of the vehicle 1, a light window 9 is provided for allowing light into the production space 3. A door 10 is provided at the rear of the vehicle 1 and serves as exit and entrance for customers when opened.

As illustrated in FIG. 2, the production space 3 includes a soya-milk heating unit 12 and a first cold store 13 for storing the soya milk used as the raw material. The first cold store 13 has a limited height and top surface on which a sink 14 is provided for washing the containers and utensils.

A work bench 15 is provided next to the soya-milk heating unit 12, for use when the soya milk is poured into a tofu die and the heated tofu is removed from the tofu die. A second cold store 16 is provided on the opposite side from the first cold store 13, for storing items of merchandise which are sold with the tofu such as sauce for the tofu, konnyaku and so on, and items other than tofu. Unsold tofu may be stored in the second cold store 16. The second cold store 16 also has a low height and a top surface serving as a work bench.

The production space 3 further includes a fixed basin 17 for washing one's hands because of the attention to cleanliness needed in the handling of food.

Another wall 18 is provided between the production space 3 and the sale space 4 adjacent thereto for defining the border between the two spaces. The wall 18 includes a sliding door 19 which is usually closed but is opened when the tofu produced is carried to the sale space 4. Thus, the production space 3 is separated from the sale space 4, so as not to allow dust and other things to enter the production space 3 from the sale space 4.

The sale space 4 includes a checkout 20 serving as a checking-out section for handling the payment for the merchandise, and a first showcase 21 for displaying freshly-made tofu. The first showcase 21 includes shelves for displaying the freshly-made warm tofu. The first showcase 21 is surrounded by walls, but has a front surface which is made of transparent glass for showing the tofu stored therein to customers. The tofu is not displayed in the first showcase 21 for a long time because the first showcase 21 is provided for selling the freshly-made warm tofu.

The sale space 4 further includes a second showcase 22 for cooling and displaying tofu. The freshly-made warm tofu is cooled to a lower temperature, and then displayed in the second showcase 22.

The vehicle 1 is parked and the rear door 10 (see FIG. 1) is opened to form the entrance 23 for customers. A stairway 24 is provided for allowing customers to go up to the sale space 4 through the entrance 23. The stairway 24 is movable and carried into the sale space 4 when the vehicle 1 is in motion.

The following describes an example of producing and selling tofu using the vehicle 1 of the embodiment.

First, the water storage tank 7 is filled with water and the waste water tank 8 is emptied. The soya milk used as the raw material for the tofu is stored in the cold store 13 in the production space 3, and the other materials and utensils required such as bittern, tofu dies and tubs for sale are loaded, and then the vehicle 1 starts.

The tofu to be sold needs to be produced before the vehicle 1 arrives at a sales site. In order to sell freshly-made warm tofu, the time involved in traveling to the sales site and the time involved in producing the tofu are calculated to prevent the production of the tofu from being finished too early or too late.

If the production of the tofu is finished too early, the tofu will be completed before arrival at the sales site. When the vehicle 1 arrives at the sales site, the tofu produced has become cold and lost its freshness by that time.

On the other hand, if the production of the tofu is too slow, the selling of the tofu cannot begin even if the vehicle 1 has arrived at the sales site, which keeps the customers waiting.

Taking into consideration the desired finishing time as described above, the soya milk with bittern should be poured into the tofu die and then placed into the soya-milk heating unit 12 for heating.

After heating, the tofu die is removed from the heating unit 12 onto the top surface of the second cold store 16 used as a work bench, and the tofu is divided into tubs for sale. The tubs of tofu are displayed in the first showcase 21 in the sale space 4.

The vehicle 1 stops at the sales site, e.g. a residential quarter, and the selling of tofu is started.

Thus, freshly-made warm tofu can be sold as a result of consideration having been given to the desired finishing time when heating the soya milk.

Further, the tofu produced is not exposed to water. This allows the sale of tasty non-watery tofu even after it has become cold.

In the foregoing embodiment, the processes of heating soya milk and of dividing the tofu are performed while the vehicle is in motion to allow the sale of the tofu to begin immediately after the vehicle has stopped at the sales site.

However, the tofu may be removed from the heating unit and divided after arrival at the sales site. This especially gives potential customers a chance to see the freshly-made steaming tofu being carried from the production space 3 to the sale space 4, and realize that the tofu is freshly produced, which will whet their appetites.

As well as being divided for sale in advance, the tofu can be sold by measure in accordance with the customer's requirments.

The freshly-made unsold tofu is displayed in the cold showcase 22 or stored in the cold store 16 in the production space 3, and the vehicle 1 moves to the next sales site.

If it is possible to park the vehicle 1 at a place where water can be procured and the waste water can be drained away while the tofu is being produced, the aforementioned water storage tank 7 and waste water tank 8 are not required. However, the provision of the water storage tank 7 and waste water tank 8 allows the production of tofu at any time in any place.

When the vehicle 1 travels along a predetermined sales route and the customer's requirements are known in advance, the amount of tofu produced can be adjusted systematically to eliminate unsold tofu.

As described above, the production of tofu while the vehicle is in motion allows sale of the freshly-made tofu on the spot. Accordingly, customers can have fresh and tasty tofu without going far to buy it.

With the vehicle 1 capable of moving to wherever customers are for sales in this way, it is possible to deliver the freshly-made tofu to, for example, the aged and the physically handicapped persons who find it hard to go far to buy tofu.

It is further possible to sign a contract with an old-age home, a facility and the like to deliver fresh tofu every morning.

It is further possible to deliver freshly-made tofu to a hotel or guesthouse for breakfast or to a school for a school-meal.

When delivering to a facility, for example, the amount of tofu required is decided in advance, which is a point of difference from sales to individual customers, and therefore the amount of materials and the like stocked can be systematically determined. However, since the facility strictly fixes the times of meals, a delay in delivering is not permitted. When a delivery time is strictly fixed, the tofu may be produced after the vehicle has stopped near the facility. Without a delay in delivering due to e.g. a traffic jam, the freshly-made tofu can be supplied at the fixed time.

The foregoing embodiment describes an example in which the sale space 4 is provided in the vehicle 1. However, even without providing the sale space 4, freshly-made tofu can be supplied if the vehicle 1 is designed for selling the tofu outside the vehicle 1.

EXPLANATION OF CODES

| | |
|---|---|
| 1 | VEHICLE |
| 3 | PRODUCTION SPACE |
| 4 | SALE SPACE |
| 5 | GENERATOR |
| 7 | WATER STORAGE TANK |
| 8 | WASTE WATER TANK |
| 12 | SOYA-MILK HEATING UNIT |
| 13 | FIRST COLD STORE |
| 14 | SINK |
| 17 | FIXED BASIN |
| 18 | WALL |
| 20 | CHECKOUT |
| 21 | FIRST SHOWCASE |
| 22 | SECOND SHOWCASE |
| 23 | ENTPANCE |

I claim:

1. A vehicle for producing and selling tofu, comprising:
a generator; and
a production space provided inside the vehicle for producing tofu, and furnished with a cold store for storing soya milk, a soya-milk heating unit, a work bench for dividing the tofu produced by the soya-milk heating unit, and a fixed basin.

2. A vehicle for producing and selling tofu, comprising:
a production space provided inside the vehicle for producing tofu; and
a sale space provided inside the vehicle for selling the tofu, produced in the production space, and furnished with showcases for displaying the tofu produced, a checking-out section, and an entrance for allowing customers to go in and out.

3. A vehicle for producing and selling tofu according to claim 1, further comprising a wall provided between said production space and said sale space.

4. A vehicle for producing and selling tofu according to claim 1, further comprising a water storage tank and a waste water tank.
